(19) United States
(12) Patent Application Publication
(10) Pub. No.: US 2026/0316101 A1
(43) Pub. Date: Oct. 15, 2026

(54) DEVICE FOR THERMAL SPRAYING, MANUFACTURING METHOD FOR MANUFACTURING SUCH A DEVICE, AND USE OF AN ADDITIVE MANUFACTURING METHOD

(71) Applicant: SMS group GmbH, Mönchengladbach (DE)

(72) Inventors: Ingo GRAMS, Solingen (DE); Thomas HOHNEN, Viersen (DE); Nina UPPENKAMP, Viersen (DE)

(73) Assignee: SMS group GmbH, Mönchengladbach (DE)

(21) Appl. No.: 19/485,554

(22) PCT Filed: May 17, 2024
(86) PCT No.: PCT/EP2024/063707

§ 371 Date: Nov. 18, 2025

(30) Foreign Application Priority Data
May 19, 2023 (DE) 10 2023 113 188.5

(51) Int. Cl. B05B 7/20; B22F 10/22; B22F 12/53; B33Y 10/00; B33Y 30/00; C23C 4/129

(52) U.S. Cl. CPC B05B 7/205; B22F 10/22; B22F 12/53; B33Y 10/00; B33Y 30/00; C23C 4/129

(57) ABSTRACT

The invention relates to a device for thermally spraying a coating material onto a substrate body to be coated, the device comprising: a burner housing part having a combustion chamber, an input side for supplying process media, and an output side for dispensing a process hot gas, the burner housing part being produced by means of an additive manufacturing method.

The invention relates to a device for thermally spraying a coating material onto a substrate body to be coated.

The invention further relates to a manufacturing method for manufacturing a device for thermally spraying a coating material onto a substrate body to be coated.

The invention additionally relates to a use of an additive manufacturing method.

Generic devices for thermal spraying are known from the prior art as HVOF burners (High-Velocity Oxygen Fuel burners), HVAF burners (High-Velocity Air Fuel burners) or the like.

In such thermal spraying, particles to be applied to a substrate body are heated using a thermal energy source and accelerated onto a surface of the substrate body. Using the particles applied in this way, one or more layers can be built up on the substrate body, in particular by adhesion and/or cohesion.

As a rule, the particles used and to be melted on or against the substrate body are in powder form.

In thermal spraying, particularly using High Velocity Oxygen Fuel (HVOF) or High Velocity Air Fuel (HVAF), process media such as kerosene, hydrogen, propane, etc. are used to produce process energy through oxidation, i.e., combustion. While conventional HVOF burners usually only use kerosene or propane and oxygen as fuel gas to produce process energy, HVAF burners can use hydrogen and/or propane in combination with compressed air to produce process energy. In addition, HVOF/HVAF systems are known in which kerosene or propane, hydrogen with nitrogen and oxygen are used to produce the required process energy.

As a rule, the combustion of the fuel gas takes place in a combustion chamber of the device for thermal spraying. At the end of such a combustion chamber there is a discharge nozzle, which is usually realized in the form of a Laval nozzle, so that the fuel gas can be further accelerated in addition to the combustion expansion. The particles or powder to be melted on or against the substrate body are usually only introduced radially into the fuel gas behind the narrowest cross-section of the discharge nozzle. Alternatively, the particles can also be introduced axially into the combustion chamber of the device for thermal spraying in the form of powder together with other gases.

However, known devices for thermal sprayings are often very energy-intensive and are therefore often ineffective to operate, which is partly due to their previous design.

The object of the invention is that of providing an improvement over or an alternative to the prior art. In particular, the invention is based on the object of being able to operate devices for thermal spraying in a more energy-efficient manner.

The object of the invention is achieved by a device for thermally spraying a coating material onto a substrate body to be coated, the device comprising a burner housing part having a combustion chamber, an input side for supplying process media and an output side for dispensing a process hot gas, wherein the burner housing part is produced by means of an additive manufacturing method.

Because the burner housing part is manufactured using an additive manufacturing method, the present device for thermal spraying can be constructed significantly more compactly, which on the one hand allows the process media required for operating the device, such as in particular fuel, and on the other hand allows heat losses at the device to be significantly reduced.

Overall, this allows the amount of energy required for thermal spraying to be significantly reduced, which makes the present device for thermal spraying much more effective to operate.

A burner housing part manufactured using an additive manufacturing method can also allow for a reduction in the number of joints between individual subtractively manufactured components, thereby eliminating any areas of the burner housing part that are susceptible to leakage of process media.

The term “additive manufacturing method” is often also referred to as generative manufacturing method, wherein additive or generative manufacturing methods, in contrast to classic subtractive manufacturing methods such as milling, drilling, turning, eroding or the like, are particularly characterized by the fact that materials can fundamentally be added layer by layer to manufacture components such as the present burner housing part advantageously more compactly.

Such additive manufacturing methods can also, in the present case, preferably completely eliminate manufacturing methods that are based on joining methods such as welding, soldering or the like.

In contrast to conventional subtractive manufacturing methods, the additive manufacturing method makes it possible to provide the present device for thermal spraying in a particularly compact manner, even if, in particular, on or especially in the burner housing part a large number of additional functional regions, functional elements or the like should be present or formed.

For the purposes of the invention, different additive manufacturing methods can be used, such as a 3D printing method, a 3D laser sintering method or the like. In particular, laser beam melting methods (LBM methods; (laser beam melting)) are also suitable for use within the meaning of the invention.

It is advantageous if formless or form-neutral materials are used for manufacture. For the purposes of the invention, formless materials are, for example, liquids, powders or the like, wherein form-neutral materials can be in the form of strips, wires or the like.

With regard to the 3D printing method mentioned above, a distinction can be made between powder bed methods, free space methods and liquid material methods.

Powder bed methods include laser beam melting (LBM), selective laser sintering (SLS), selective heat sintering (SHS), binder jetting (solidification of powder material using a binder) and electron beam melting (EBM).

Free-space methods include fused depositing modeling (FDM) or fused filament fabrication (FFF), laminated object modeling (LOM), cladding, wax deposition modeling (WDM), contour crafting, cold injection molding and electron beam welding (EBW).

Liquid material methods include, for example, stereolithography (SLA) and micro-SLA, digital light processing (DLP) and liquid composite molding (LCM).

Among others, the following materials can be used in the above methods: 1.2709, 1.4540, 1.4542, 1.4404(316 L), AlSi10Mg, Scalmalloy®, CuNi2SiCr, CuCr1Zr, pure copper, CoCrW, Inconel 718, Inconel 625, TiAl6V4, Hastelloy® C22. In other words, the device for thermal spraying produced by an additive manufacturing method may comprise one of the above materials or consist of one of the above materials, wherein any coatings applied after the additive manufacturing method are not to be taken into account.

A more compact design in the sense of the invention can be achieved particularly easily if the manufacture takes place at least partly from a data set for operating a single production facility. Preferably, only a single data set is required for production, in which all information for producing, in particular, the present burner housing part is included.

The present device for thermal spraying can be designed for different thermal spray application methods, including an HVOF burner device for thermal spraying or an HVAF burner device for thermal spraying.

Furthermore, the present device for thermal spraying can, when appropriately designed, be provided in the sense of an external coating device for thermally spraying an external coating onto a substrate body or for thermally coating a substrate body, such as a roller part, a pipe part, a drum part or the like, or alternatively in the sense of an internal coating device for thermally spraying an internal coating onto a substrate body or for thermally coating the inside of a substrate body.

The term “combustion chamber” describes a functional region of the device for thermal spraying within the burner housing part in which selected process media are introduced, ignited and dispensed as hot gas at accelerated rates. In this respect, the burner housing part can also be regarded as the actual “burner” of the present device.

The term “input side” describes a region of the burner housing part, in particular in front of (upstream of) the combustion chamber, in which supply lines for process media are arranged.

This input side can in particular be designed as a region between a receiving surface for receiving an external connection part for the cumulative supply of process media and the head side of the combustion chamber.

The term “output side” describes a region of the burner housing part, in particular behind (downstream of) the combustion chamber, in which in particular the hot gas channel for discharging the hot gas out of the combustion chamber is arranged.

Preferably, the hot gas channel may have a curved section, wherein the curved section is configured to redirect the process hot gas within the burner housing part. The curved section can redirect the process hot gas by greater than or equal to 10°, preferably by greater than or equal to 25° and particularly preferably by greater than or equal to 45° or greater than or equal to 75°. Furthermore, the curved section can preferably redirect the process hot gas by greater than or equal to 60°, preferably by greater than or equal to 80° and particularly preferably by greater than or equal to 85° or greater than or equal to 90°.

This output side can in particular be designed as a region between a receiving surface for receiving an external head part and the foot side of the combustion chamber.

It is advantageous if the burner housing part is formed monolithically.

Due to a monolithic shape or construction, the burner housing part can be realized extremely simply, whereby its construction can be reduced to an extremely simple design.

In particular, the combustion chamber and especially the regions around the combustion chamber can be material-optimized and thus built very compactly.

Overall, this can significantly reduce energy losses in the device, allowing the device to be operated more efficiently.

In this respect, the burner housing part is preferably formed as a single monolithic block.

In other words, this means that the combustion chamber as well as the input and output sides are physically formed as a single monolithic block.

A “monolithically” formed component is understood to mean, in particular, a component of the device, such as the burner housing part, which is manufactured in a single, continuous and seamless component.

In other words, a monolithically formed burner housing part is not composed of multiple individual parts and is also not integrally joined by a plurality of individual parts, for example by means of a welding method.

The burner housing part can be designed to be particularly compact if the input side and the output side are formed monolithically with each other.

This in particular makes it possible to dispense with additional connecting elements or component interfaces, especially in relation to the combustion chamber, which can particularly effectively reduce the risk of heat loss.

In particular, an advantageous reduction of component interfaces allows for a smaller and thus more compact design of the device for thermal spraying, in particular also its burner housing part.

Conventional devices for thermal sprayings have always been formed in several parts.

In the present case, the number of required components for the device for thermal spraying can be reduced favorably.

Due to the large number of different components used and the associated, in particular, more voluminous construction, in particular with regard to a greatly enlarged surface compared to the environment, the prior art results in significantly greater and/or more unevenly distributed heat losses compared to the environment over the device than is the case with the present device for thermal spraying, in particular with regard to comparable combustion chamber sizes.

Especially in this context it is advantageous if transition regions between the combustion chamber and the input side and the output side are formed monolithically.

As a result, the burner housing part can be built even more compactly.

It is particularly advantageous that the additive manufacturing method allows cavities to be created particularly advantageously in the burner housing part.

In this respect, it is advantageous if the burner housing part has material recesses, in particular internal material recesses, wherein interfaces between the material recesses and the burner housing part are formed monolithically.

Such material recesses can be shaped in almost any way using the additive manufacturing method, or in any case in a more diverse way than is usually possible with subtractive manufacturing methods.

In particular, the interfaces can be formed or shaped in a tangentially continuous manner.

The interfaces can be designed or shaped as free-form surfaces.

This allows the material recesses to be free of disadvantageous edges, sudden cross-sectional changes or the like.

It is also advantageous if structures are arranged on or within material recesses of the burner housing part, wherein the structures and the burner housing part are formed monolithically.

Such structures can be shaped differently in order to be able to perform different functions, particularly with regard to the burner housing part.

For example, the structures can be formed or shaped as material meshes, guide elements or the like on the burner housing part or within the burner housing part.

Furthermore, it is advantageous if the input side has a first supply line for a primary fuel, wherein the first supply line and the combustion chamber are formed monolithically.

This allows the burner housing part to be designed to be structurally simple, in particular with a small number of component interfaces on the present device for thermal spraying.

If the input side has additional supply lines for additional process media, wherein the additional supply lines and the combustion chamber are formed monolithically, the burner housing part can continue to be built very compactly despite a large number of supply lines.

This compact design can also be applied to specific embodiments of the device for thermal spraying, in which at least one first additional feed line for material transport is directly connected to a pre-combustion chamber and a second additional feed line for material transport is directly connected to the main combustion chamber, wherein the additional feed lines can be configured to guide the materials to the corresponding regions of the pre-combustion chamber or the main combustion chamber as required.

If the output side has a hot gas channel, wherein the hot gas channel and the combustion chamber are formed monolithically, the burner housing part can also be designed to be very compact at its output end.

The present device for thermal spraying can be designed in a simpler way in the sense of an internal coating device if the hot channel has at least one curved section.

It is understood that such a curved section within the burner housing part, in particular within the output end thereof, can be structurally produced by means of an additive manufacturing method.

In particular, internal curved material recesses can be manufactured advantageously and with high aerodynamic quality within the burner housing part using an additive manufacturing method. This applies equally to the hot gas channel, other supply lines, the combustion chamber or the like.

The construction of the burner housing part can be particularly simplified if supply lines for supplying process media on the input side of the burner housing part and a hot gas channel for discharging a hot gas on the output side of the burner housing part are formed monolithically.

In any case, the present device for thermal spraying can be operated much more effectively due to its monolithic design.

In addition to the more effective operation of the present device for thermal spraying already described above, the additive manufacturing method proposed here also allows for particularly simplified production.

Until now, almost every function on a device for thermal spraying was assigned a separate component, which was also manufactured conventionally, i.e., using subtractive manufacturing methods.

In this case, in particular, however, the burner housing part preferably consists of only a single component, which also means that the production of the present device for thermal spraying as a whole can be considerably simplified; in particular, the time required for assembly and/or disassembly work can be significantly reduced.

In particular, the burner housing part can significantly reduce the number of component interfaces on the device for thermal spraying according to the invention, as will be described in more detail later.

At this point, only a few components of conventional devices for thermal sprayings are mentioned as examples, which require component interfaces that can be eliminated or at least significantly reduced in the present case, such as with regard to the combustion chamber housing part in general, with regard to the combustion chamber, a kerosene or propane nozzle or a burner mixing nozzle in particular, etc.

In particular, the high time expenditure to date is due to the many existing component interfaces, all of which must be properly assembled and sealed in order to provide a flawless and reliable device for thermal spraying using the prior art. Improper assembly, for example, can lead to process media mixing too early or generally unintentionally, which can result in, for example, “only” reduced performance or, in the worst case, an explosion in the device for thermal spraying.

If, in particular, the burner housing part is manufactured according to the invention using an additive manufacturing method, the number of required component interfaces can be considerably reduced.

In this case, in particular, a reduction in the number of components, a simplification of disassembly and assembly work and an increase in the functional reliability of the device for thermal spraying proposed here can be achieved.

The structure of the present device for thermal spraying can be advantageously constructed if the device has a head part with a discharge nozzle element and with an injector element for injecting coating material into the head part, wherein the head part is produced by means of an additive manufacturing method.

The device for thermal spraying can be designed in a simple manner if the head part and the burner housing part are formed monolithically, in particular formed as a single monolithic block.

This allows the number of component interfaces to be kept low, which means that the advantages already described above can be easily achieved, particularly with regard to the more compact design.

Furthermore, the head part can preferably be designed to be integrated into the burner housing part, wherein the head part and burner housing part are formed monolithically. As a result, the functionality of the head part can advantageously be combined with the functionality of the burner housing part in a common monolithic component, in particular in a monolithic burner housing part.

Wear-prone components of the head part can be replaced more easily on the device for thermal spraying if the head part and the burner housing part are firmly but detachably operatively connected to each other.

This allows the entire head part to be easily replaced.

In the latter variant, the functional components “burner housing part” and “head part” of the device for thermal spraying are operatively connected to each other, for example with a screw connection.

The component interface provided here can be sealed with suitable sealing means, in particular with sealing elements, preferably with one or more sealing rings.

To arrange the detachable head part, it is advantageous if the device has a receiving surface for receiving the head part, wherein the receiving surface and the burner housing part are formed monolithically.

In addition, it is useful if the device comprises an injector tube part for providing coating material to an injector element of a head part of the device, wherein the burner housing part forms a holder for holding the injector tube part.

### This Allows the Injector Tube Part to Be Arranged in a Defined Manner on

the burner housing part.

In order to improve the thermal properties of the device for thermal spraying, it can be made of a material with a thermal conductivity of less than or equal to 50 W/mK, preferably less than or equal to 40 W/mK, particularly preferably less than or equal to 30 W/mK or less than or equal to 20 W/mK. In a particularly preferred embodiment, the device is produced from the material 1.4404 (316 L) by means of an additive manufacturing method, which has a thermal conductivity of 15 W/mK.

Alternatively, the device for thermal spraying can be produced by means of an additive manufacturing method from copper (thermal conductivity: ~399 W/mK) or aluminum (thermal conductivity: ~237 W/mK) or bronze (thermal conductivity: ~62 W/mK) or a steel with a thermal conductivity of less than or equal to 50 W/mK.

Optionally, the material from which the burner housing part was produced by additive manufacturing has a thermal expansion coefficient of less than or equal to 15*10⁻⁶ K⁻¹.

In order to homogenize the distribution of the coating material in the hot gas stream emerging from the discharge nozzle and/or to reduce adhesion of coating material to the surface of the discharge nozzle, the injector element can be arranged in the device for thermal spraying such that the coating material can be supplied to the hot gas stream at an angle of less than or equal to 50° to the main coating axis of the device for thermal spraying, preferably at an angle of less than or equal to 25° and particularly preferably at an angle of less than or equal to 15° or even less than or equal to 5°.

Particularly preferably, the head part can be monolithically integrated into the burner housing part.

Preferably, a part of the burner housing part enclosing the combustion chamber can be fixedly mounted on both sides of its longitudinal direction of extent in relation to a region of the burner housing part forming the outer wall of the device for thermal spraying.

In order to improve the cooling of the pre-combustion chamber, the latter can be surrounded by the internal cooling on its outer wall in a region of greater than or equal to 70% of its total longitudinal extent, preferably greater than or equal to 80% and particularly preferably greater than or equal to 90% or even greater than or equal to 95%.

An embodiment variant can be advantageously designed if the device has a cooling device for cooling the substrate body, wherein the cooling device or at least regions thereof and the burner housing part are formed monolithically.

Due to this monolithic design or construction, the present device for thermal spraying can still be realized in an extremely compact manner despite additional functional scopes, in particular despite an integrated substrate body cooling device.

This is particularly advantageous if the present device for thermal spraying is used in the sense of an internal coating device, where an extremely compact design is particularly important in order to be able to insert the device for thermal spraying sufficiently well even into the tight spaces of a substrate body.

For example, the present device for thermal spraying can be used to easily carry out thermal internal coatings on pipes or the like, even with small internal diameters of less than 100 mm.

Advantageously, by means of the present device for thermal spraying, the substrate body can be cooled immediately and effectively during a thermal coating process in order to be able to effectively counteract the process heat introduced into the substrate body.

This alone makes particularly stable coating processes possible throughout, even with difficult internal dimensions on a substrate body to be thermally coated.

Previously known devices for thermal spraying provide that the combustion chamber has a separate combustion chamber housing relative to the housing of the entire device, wherein this separate combustion chamber housing is axially fixedly mounted on one side within the housing of the entire device, while on the correspondingly opposite side it is only loosely mounted in the axial direction. This bearing principle requires that the combustion chamber housing is fixedly supported on the side of the hot gas channel, whereby at least a free cross section for supplying reactants for combustion depends on the expansion state of the combustion chamber, so that a stable, constant coating process cannot be ensured.

Accordingly, the monolithic structure of the combustion chamber housing in combination with the housing of the device for thermal spraying proposed here advantageously ensures that predominantly constant geometric conditions can be ensured, whereby a constant volume flow of the reactants for combustion and/or a stable coating process can be achieved with the device proposed here.

Thus, optimal coating results can be achieved on a substrate body using the proposed device for thermal spraying.

In addition, it is advantageous if the cooling device has at least one coolant channel for guiding coolant, which extends in particular from the input side of the burner housing part to the output side of the burner housing part, wherein the at least one coolant channel and the burner housing part are formed monolithically.

Due to the monolithic shape and design in particular, one or even several coolant channels can be compactly integrated into the present device for thermal spraying.

In particular, such coolant channels can be compactly connected from the input side to the output side through the burner housing part.

Furthermore, it is advisable if the cooling device has at least one cooling nozzle for ejecting coolant, which nozzle is arranged in particular on the output side of the burner housing part, wherein the at least one cooling nozzle and the burner housing part are formed monolithically.

In order to carry out a thermal coating process more advantageously, it is advantageous if the at least one cooling nozzle and the discharge nozzle have different directions of action. This can reduce the risk that the application of coatings to a substrate body is negatively influenced by coolant.

Especially when using the device for thermal spraying in the sense of an internal coating device, it is advantageous if the at least one cooling nozzle is arranged opposite the receiving surface for receiving the head part on the burner housing part. This allows the coolant and the coating material to be applied to opposite regions of the substrate body independently of one another.

Different coolants can be used in this case. Preferably, the cooling device is designed so that compressed air, nitrogen, in particular gaseous nitrogen and/or a gaseous mixture of nitrogen and oxygen, carbon dioxide, inert gases or the like can be sprayed by means of the at least one cooling nozzle.

Furthermore, it is advantageous if the at least one cooling nozzle has a main ejection axis which is arranged at an angle of 15° or more and 75° or less, preferably at an angle of 45°, relative to a main coating axis of the discharge nozzle.

The main ejection axis and the main coating axis are the same as the central axis of the corresponding nozzle.

If the present device is used for thermal spraying in the sense of an internal coating device, the angle mentioned here is similar, but is preferably opposite to the receiving surface for receiving the head part, mirrored on the central axis of the device for thermal spraying or burner housing part thereof.

Preferably, in the present case, an offset of the point of impact of the coolant on the substrate body of at least 3×the coating spot diameter before and/or after the coating point and of a maximum of 20×the coating spot diameter before and/or after the coating point, preferably of 10×the coating spot diameter before and/or after the coating point is selected, wherein the term “before” is to be understood in the sense of the relative movement vector.

The coating spot diameter depends in particular on the size of the device for thermal spraying and the spraying distance. For a smaller device, this coating spot diameter is preferably approximately 4 mm to 7 mm, and for a larger device, it is preferably approximately 12 mm to 15 mm.

In this case, the coolant can be distributed sufficiently well using a single cooling nozzle. Preferably, four cooling nozzles are provided in order to achieve particularly good cooling quality. In order to minimize the installation space occupied by cooling nozzles on the burner housing part in the frame, preferably up to 12 cooling nozzles can be provided.

In order to always obtain a sufficiently wide cooling fan with regard to a coolant, it is advantageous if the cooling nozzles each have an opening angle of 0° (parallel direction) and at most 75° or less, preferably an opening angle of 15°, with respect to their corresponding central axes or main ejection axes.

Furthermore, it is useful for cooling in the case of a device for thermal spraying used in the sense of an internal coating device if the position of the cooling nozzle openings relative to the central axis of the device for thermal spraying or burner housing part thereof are arranged offset from the main coating axis by at least 15° or more or by a maximum of 345° or less, preferably by 180°.

By means of such a cooling device, the present device for thermal spraying can be advantageously further developed, in particular by ensuring that a consistently reproducible substrate body cooling can be ensured.

A generic device for thermal spraying can be advantageously further developed solely by means of the present substrate body cooling device, so that relevant features or combinations of features are already advantageous without the other features of the invention.

The present device for thermal spraying can be further developed positively by a flame arrester device, wherein the flame arrester device and the burner housing part are formed monolithically.

Due to such a monolithic design or construction, the number of separate functional components can be kept low despite an extended range of functions, whereby in particular the burner housing part can be provided compactly.

Preferably, such a flame arrester device is arranged as a flame protection barrier in a supply line for process media, in particular for fuels such as hydrogen, in order to prevent a “flame” from the combustion chamber from flashing back critically far into the supply line.

By means of the flame arrester device, the operational safety of the device for thermal spraying can be advantageously increased, in particular in view of the fact that the present device for thermal spraying can, for example, have a hydrogen requirement of between 25 NL/min and 1000 NL/min at an operating pressure of approximately 5 to 25 bar.

If the flame arrester device has a material mesh, in particular a thin-meshed material mesh, wherein the material mesh and the burner housing part are formed monolithically, the flame arrester device can be integrated extremely compactly into the burner housing part.

In addition, the flame arrester device can be produced with extremely low manufacturing costs.

A particularly good functional reliability can be achieved by the present flame arrester device by means of at least one of the following features:

Preferably, the material mesh has a mesh size of less than or equal to 1 mm, preferably less than or equal to 0.5 mm, and more preferably less than or equal to 0.1 mm.

Further preferably, the material mesh has a mesh size greater than or equal to 0.01 mm, preferably greater than or equal to 0.1 mm, and more preferably greater than or equal to 0.5 mm.

The mesh size is to be understood as the width of the material mesh through which air can flow freely. A material mesh can also be described by its pitch, wherein the pitch describes the distance between the centroids of adjacent meshes of the material mesh.

The material mesh may have a pitch of less than or equal to 1.2 mm, preferably less than or equal to 0.6 mm and particularly preferably less than or equal to 0.15 mm. The material mesh can have a pitch of greater than or equal to 0.02 mm, preferably greater than or equal to 0.15 mm and particularly preferably greater than or equal to 0.6 mm.

Such a mesh size and/or pitch can be produced using an additive manufacturing method.

Cumulatively or alternatively, it is advantageous if the material mesh has a base area of 20 mm² or more, and of 700 mm² or less, preferably 175mm².

This allows the flame arrester device to be easily designed or shaped to suit different pipe cross-sections or similar.

Advantageously, the base area can easily have different basic shapes by means of the additive manufacturing method, in particular can be designed as a free form. Preferably, the base area is circular or elliptical in shape. However, the base area can also be rectangular, square or similarly shaped, in particular depending on a pipe cross-section in the burner housing part.

The base area is the cross-sectional area of the flame arrester device.

Cumulatively or alternatively, it is advantageous if the material mesh has a length of 15 mm or more and 90 mm or less, preferably 30 mm, whereby installation space lengths of the flame arrester device can be produced as required.

In addition, it is expedient if the flame arrester device is also designed to produce a pressure difference between 0.25 bar and 1.5 bar.

In any case, a flame arrester device formed or shaped this way allows for good flame flashback protection while simultaneously allowing a good flow of a process medium.

A generic device for thermal spraying can be advantageously further developed solely by means of the present flame arrester device, so that relevant features or combinations of features are already advantageous without the other features of the invention.

In addition, the device for thermal spraying itself can be cooled particularly well if the device has an internal cooling system for cooling the device, wherein the cooling device and the burner housing part are formed monolithically.

Thanks to a monolithic design, internal cooling can be particularly efficient, which in particular optimizes combustion. This allows the present device for thermal spraying to be operated more efficiently.

Heat dissipation can be advantageously designed in the present case if the internal cooling has at least one cooling channel, preferably a plurality of cooling channels, wherein the at least one cooling channel or the cooling channels and the burner housing part are formed monolithically.

Furthermore, it is expedient if the at least one cooling channel is designed close to the contour, in particular close to the contour around the combustion chamber of the burner housing part and a hot gas channel of the burner housing part.

The combustion chamber and/or hot gas channel have a predominantly oval wall, in particular a circular and/or elliptical wall, which geometrically delimits an interior of the combustion chamber and/or hot gas channel from any other components of the device for thermal spraying.

It has been shown that the wall of the combustion chamber and/or the hot gas channel preferably has a constant wall thickness, whereby the structural requirements and/or the thermodynamic equilibrium at a stationary operating point of the device for thermal spraying can be advantageously influenced.

In the sense of this description, “close to the contour” can therefore be understood to mean that the cooling channel is directly adjacent to the outside of the wall of the combustion chamber and/or the hot gas channel, so that an advantageous cooling effect of the combustion chamber and/or the hot gas channel can be achieved.

In this way, the cooling channel can have a predominantly oval inner wall, in particular a circular and/or elliptical inner wall, which can extend around the wall of the combustion chamber and/or the hot gas channel.

Preferably, the cooling channel has a predominantly constant thickness through which free flow can take place.

This allows for particularly uniform heat dissipation.

An even more uniform cooling of the device for thermal spraying can be achieved if the at least one cooling channel is formed in a ring shape on the head part, in particular in a ring shape around the discharge nozzle.

In the present case, particularly uniform cooling can be achieved on the burner housing part if the at least one cooling channel extends from the input side to the output side through the burner housing part.

The heat dissipation, especially from the burner housing part, can be further improved if the at least one cooling channel extends helically within the burner housing part, wherein in particular a cooling channel helix has at least one flight and up to 16 flights.

The helix may have a pitch of greater than or equal to 0.05 in the longitudinal direction of extent of the combustion chamber, preferably a pitch of greater than or equal to 0.1, and particularly preferably a pitch of greater than or equal to 0.15 or greater than or equal to 0.2. Preferably, the pitch of the helix is less than or equal to 9.4, preferably less than or equal to 0.35 and particularly preferably less than or equal to 0.3 or less than or equal to 0.25.

Preferably, such a cooling channel helix extends within the burner housing part from its input side to its output side. Depending on the application, the cooling channel helix can also be formed shorter, for example starting later on or only behind the input side of the burner housing part.

The coolant can be guided more effectively within the cooling channel if the internal cooling has guide elements for guiding a coolant, wherein the guide elements and the burner housing part are formed monolithically.

If guide elements extend helically within the burner housing part, the coolant can be guided in a helical manner within the burner housing part, whereby particularly uniform cooling at the burner housing part can be ensured.

Such a guide element helix has at least one single flight and the guide element helix can preferably have up to 16 flights.

Such flights can be provided particularly easily within the cooling channel if the flight or flights and the burner housing part are monolithically formed or shaped.

In addition, it is useful if guide elements are arranged individually one behind the other within the burner housing part, in particular within the at least one cooling channel, wherein in particular the individually arranged guide elements each have a length of 3 mm or more and of 50 mm or less.

By shaping the guide elements in this way, a good mixing of the coolant on its way through the burner housing part can be achieved.

An additional mixing of coolant within the cooling channel can be achieved relatively easily by designing guide elements with a curved profile to give the coolant an additional swirling movement.

The burner housing part can also be made compact if guide elements have a wall thickness of 0.1 mm or more and 5 mm or less.

On the one hand, such dimensioning can ensure sufficient strength of the guide elements. On the other hand, the guide elements can be shaped delicately enough to make the volume of the cooling channel as voluminous as possible.

Advantageously, the internal cooling, in particular a cooling chamber provided thereby, can have an area of 25 mm² or more, preferably 34.5 mm² or more, or 400 mm² or less, preferably 330 mm² or less, depending on the cooling requirement.

Furthermore, it should be mentioned at this point that a required coolant volume flow also depends on an inlet temperature of the coolant, with which it is introduced into the burner housing part, in particular on the input side.

In addition, the maximum permissible temperature delta between the input and output of the cooling channel must also be observed. As a rule, this temperature delta is between 5° C. and 30° C., particularly depending on the burner output.

Typically, a coolant flow of at least 5 l/min to max. 60 l/min at a pressure of at least 1 bar to max. 20 bar is required.

In order to further increase the process reliability of the cooling, it is expedient if the cross-sectional area of the cooling channel is shaped in such a way that a counterpressure acting on the coolant can be produced, which is greater in the region of the output side of the burner housing part than in the region of the input side of the burner housing part.

In addition to a corresponding number, arrangement and/or shape of guide elements in the cooling channel, cumulatively or alternatively the cross-sectional area of the cooling channel in the region of the output side of the burner housing part can have a smaller value than in the region of the input side of the burner housing part.

A favorable reduction in the cross-sectional area of the cooling channel is preferably 2% or more, or 30% or less, particularly preferably 20%.

A suitable reduction can preferably be achieved by reducing the cross section of the cooling channel, cumulatively or alternatively by widening a profile of guide elements. Also by means of a steadily steepening coolant helix or cooling channel helix in the burner housing part, a reduction of the cross section of the cooling channel can be easily achieved.

In order to be able to reduce the size of the burner housing part or in particular the combustion chamber thereof, a return channel for the coolant can also be arranged around hot gas-carrying components, such as the combustion chamber or the hot gas channel, in a flight of a cooling channel helix separate from the cooling channel helix in order to be able to dissipate additional heat energy from the burner housing part.

The discharge nozzle can be soldered to the head part and/or the burner housing part. In particular, the discharge nozzle can be accommodated by the head part and/or the burner housing part on the outside of the discharge nozzle, in particular to greater than or equal to 75% of an axial extent of the discharge nozzle, preferably to greater than or equal to 85% and particularly preferably to greater than or equal to 92.5% or 96.5%.

The discharge nozzle can be connected to the head part and/or the burner housing part by means of a soldered connection.

To improve the cooling of the discharge nozzle, the internal cooling can extend into the region of the head part and/or the burner housing part corresponding to the discharge nozzle. Thus, a longitudinal extent region of the discharge nozzle of greater than or equal to 60% of a total longitudinal extent of the discharge nozzle can be encompassed by the internal cooling of the device for thermal spraying, preferably of greater than or equal to 80% and particularly preferably of greater than or equal to 90% or greater than or equal to 95%.

In order to operate the device for thermal spraying even more effectively, it is advantageous if supply lines for process media in the burner housing part are designed to be tangentially continuous.

This allows even supply lines located deep in the burner housing part to be designed or shaped to optimize flow, so that the efficiency of the device for thermal spraying can be further improved.

This particularly applies to supply lines for process media such as kerosene or propane, hydrogen, propane, but also compressed air, oxygen, nitrogen or the like.

In particular, the interfaces of corresponding supply lines can be designed or formed to be tangentially continuous.

In any case, a reduction in the pressure loss in a supply line can also be achieved in this case. The achievable pressure loss is preferably between 0.5 bar and approximately 5 bar, depending on the corresponding process medium.

The interfaces can be designed or shaped as free-form surfaces.

In this case, the supply lines can expediently be designed or shaped free of disadvantageous edges, sudden cross-sectional changes or the like.

This allows a process medium to flow as consistently as possible in the supply lines in a laminar manner.

In this respect, energy consumption can be reduced and the device for thermal spraying can be operated more efficiently overall.

By means of supply lines designed or shaped in this way, an improvement in combustion processes in the combustion chamber can also be achieved.

Overall, the supply lines created here can also prevent or at least significantly reduce the risk of critical turbulence, vortices or the like in the supply lines.

A further increase in efficiency can be achieved if openings, in particular nozzle openings, of a nozzle arrangement on the combustion chamber are formed monolithically with the burner housing part.

The primary injection of process media into the combustion chamber takes place, if possible, at the head side of the combustion chamber.

If required, process media such as oxygen, nitrogen, compressed air or similar can also be injected into the combustion chamber as secondary injection.

Secondary openings, in particular secondary nozzle openings, of the secondary injections are located behind the primary injection as seen in the flow direction or in the longitudinal direction of the burner housing part.

Preferably, process media are injected at one location or region of the burner housing part, especially at the head side of the combustion chamber, into the combustion chamber, maximally at two locations or regions distributed over the length of the combustion chamber.

Accordingly, the primary nozzles and secondary nozzles are formed on the burner housing part, especially on the combustion chamber.

The injection of process media is preferably carried out using several primary nozzles or secondary nozzles.

In this respect, it is useful if primary and secondary nozzles are formed monolithically with the burner housing part on the combustion chamber.

Here, openings of primary or secondary nozzles can be arranged evenly distributed at the interface of the combustion chamber, in particular concentrically around the central axis of the burner housing part.

Alternatively, an opening for injecting a process medium can also be designed or formed in a ring shape as an annular gap, in particular concentrically around the central axis of the burner housing part.

In order to achieve an even better mixing of the process media in the combustion chamber, the relevant process media can be injected at different angles compared to a process media stream, such as kerosene or propane, which is injected centrally and axially at the head side.

While the centrally and axially injected process media flow along a central axis of the burner housing part, in particular the combustion chamber, the other process media are preferably injected in a helical shape.

The different process media preferably have a different pitch depending on the distance from the central axis. The pitch is preferably in the same direction (e.g., clockwise), but can also be in the opposite direction (e.g., counterclockwise).

This allows for further improved mixing of the process media within the combustion chamber and thus better combustion within the combustion chamber.

A generic device for thermal spraying can be advantageously further developed solely by means of the present primary or secondary nozzles, so that relevant features or combinations of features are already advantageous without the other features of the invention.

In order to further improve the combustion of process media within the combustion chamber, it is advantageous if an interface of the combustion chamber has a plurality of valleys and/or grooves, wherein the valleys and/or grooves and the burner housing part are formed monolithically.

If an interface or surface of the combustion chamber is equipped with such valleys and grooves, the injected process media can be advantageously set in rotation within the combustion chamber along the central axis of the burner housing part, which can improve combustion.

Preferably, the interface of the combustion chamber is varied in terms of its surface quality from the head side (process media input) of the combustion chamber to the opposite foot side (hot gas output) of the burner chamber, for example by means of a continuous or sudden change in the number of valleys and grooves.

Alternatively, a uniform rotation of valleys and grooves around the central axis of the burner housing part or the combustion chamber or a discontinuous rotation of valleys and grooves around this central axis can also be provided.

Furthermore, in particular a very good heat transfer into the material of the burner housing part and thus also into a cooling channel can be achieved if one interface of the combustion chamber has a roughness Rₐ of 5 μm or more, or a roughness Rₐ of 100 μm or less, preferably a roughness Rₐ of 20 μm.

Such a roughness Rₐ (mean roughness value Rₐ) can be formed particularly easily within a monolithic block-like burner housing part using an additive manufacturing method.

The measures described above alone can improve combustion processes in the combustion chamber, resulting in fewer pollutants being released into the environment.

Overall, this can increase the efficiency of the present device for thermal spraying.

Furthermore, it is desirable to be able to effectively utilize the process heat produced in the combustion chamber.

For this purpose, it is advantageous if a wall of the combustion chamber has a plurality of cavities, in particular pores, preferably circular pores, wherein the cavities have a diameter which is selected depending on a wall thickness of a wall of the combustion chamber.

By means of suitable cavities, the thermal conductivity at the interface of the combustion chamber or at the wall of the combustion chamber can be reduced, whereby the process heat within the combustion chamber can be used more efficiently.

Such cavities can be produced particularly easily if the cavities and the burner housing part are monolithically formed or shaped.

Furthermore, it is advantageous if the diameter of a cavity is 10% of the wall thickness or more, or 75% of the wall thickness or less, preferably 50% of the wall thickness.

This can also lead to the thermal conductivity at the burner housing part being positively improved in accordance with the invention.

A more uniform temperature distribution can be achieved if the cavities are uniformly distributed over the surface of the wall of the combustion chamber.

To prevent the cavities from being directly flowed through by a coolant and thus preventing undesired heat dissipation, it is advisable to arrange the cavities separately from a coolant located in a cooling channel.

With the features of the cavities described above, the process heat at the device can be used more efficiently.

The object of the invention is further achieved by a manufacturing method for manufacturing a device for thermally spraying a coating material onto a substrate body to be coated, in which at least one burner housing part of the device is produced by means of an additive manufacturing method.

In this way, the device or the burner housing part can be advantageously produced, in particular with fewer individual components, component interfaces, material usage and maintenance-free. This means that the device or the burner housing part can be made smaller and more compact overall. All this results in the device being able to operate more efficiently, as already described in detail above.

At this point, it should additionally be claimed that the described method can also be supplemented by further technical features described here, in particular by features of the device, in order to advantageously further develop the method or to be able to represent or formulate method specifications even more precisely.

According to a further aspect, the stated object of the invention is also achieved by a use of an additive manufacturing method for producing a burner housing part of a device for thermally spraying a coating material onto a substrate body to be coated.

This allows the burner housing part to be manufactured much more compactly and with more optimized flow, which allows the device to be operated more efficiently.

It should also be pointed out here that, in the context of this patent application, indefinite articles and indefinite numerical indications such as “one . . . ,” “two . . . ,” etc., are as a rule to be understood as “at least” indications, i.e., as “at least one . . . ,” “at least two . . . ,” etc., unless it is clear from the context or the specific text of a particular passage that only “exactly one . . . ,” “exactly two . . . ” etc., is meant.

It should also be noted at this point that, in the context of the present patent application, the term “in particular” should always be understood as introducing an optional, preferred feature. The expression should not be understood to mean “specifically” or “namely.”

Further advantages, details, and features of the invention can additionally be found in the exemplary embodiments described below.

Here, components that are at least substantially identical with regard to their function in the individual figures can be identified by the same reference signs, wherein the components need not be numbered and described in all figures.

In the drawing:

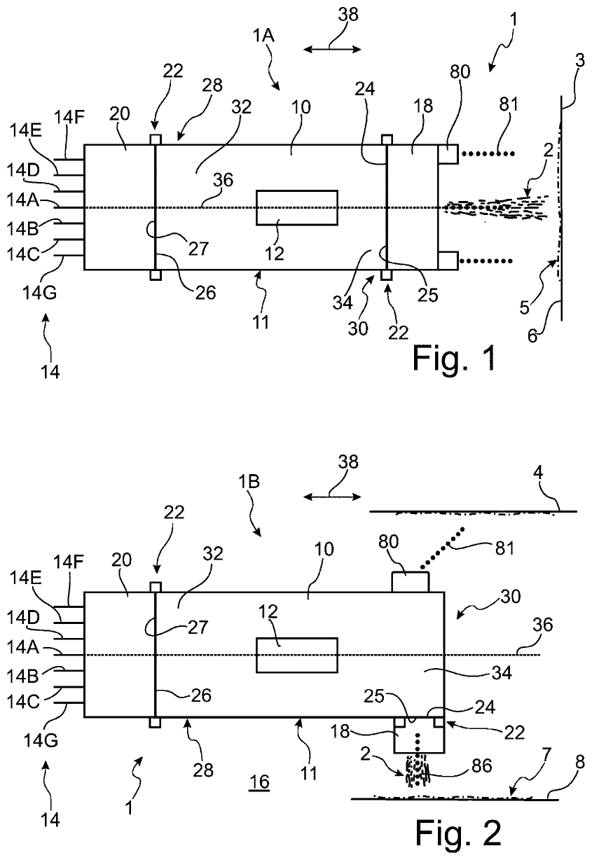

FIG. 1 schematically shows a side view of a first embodiment of the device for thermal spraying in the form of an external coating device for thermally spraying an external coating on a substrate body;

FIG. 2 schematically shows a side view of a second exemplary embodiment of the device for thermal spraying in the form of an internal coating device for thermally spraying an internal coating on a substrate body;

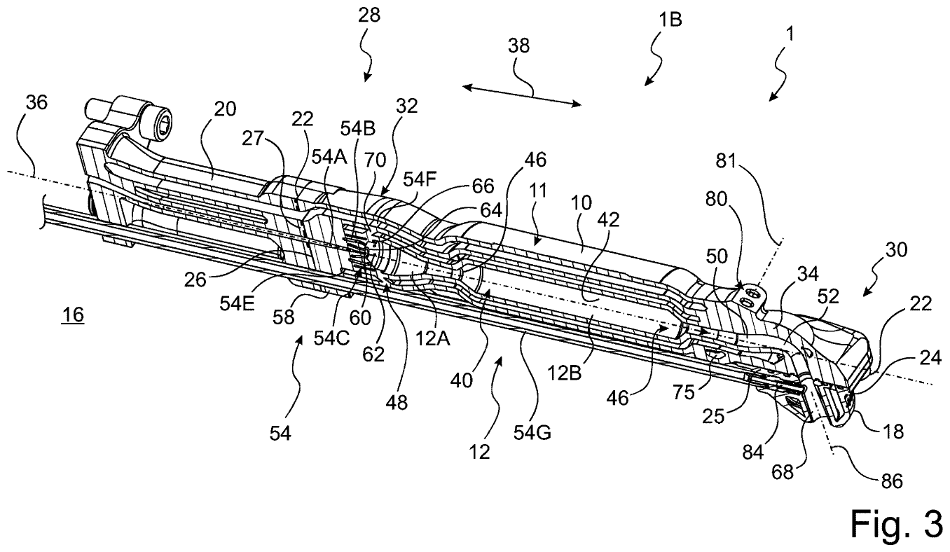

FIG. 3 schematically shows a first partial sectional view of the device for thermal spraying according to the second exemplary embodiment of FIG. 2;

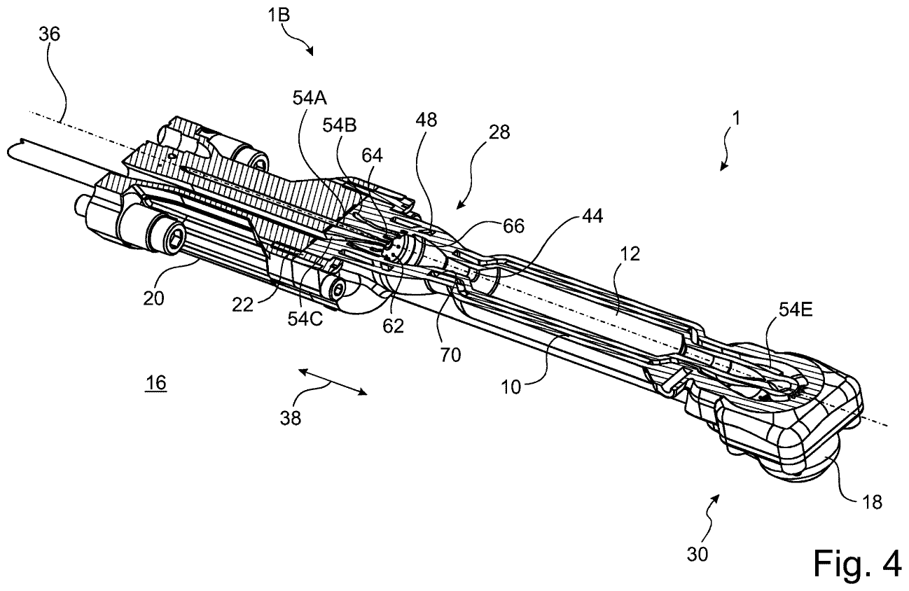

FIG. 4 schematically shows another partial sectional view of the device for thermal spraying according to the second exemplary embodiment of FIG. 2;

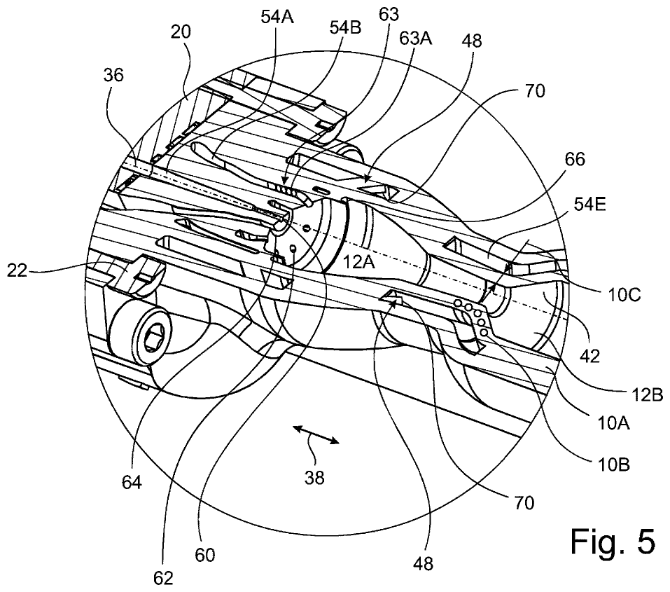

FIG. 5 schematically shows a partially sectional detailed view of the device for thermal spraying according to the second exemplary embodiment of FIG. 2;

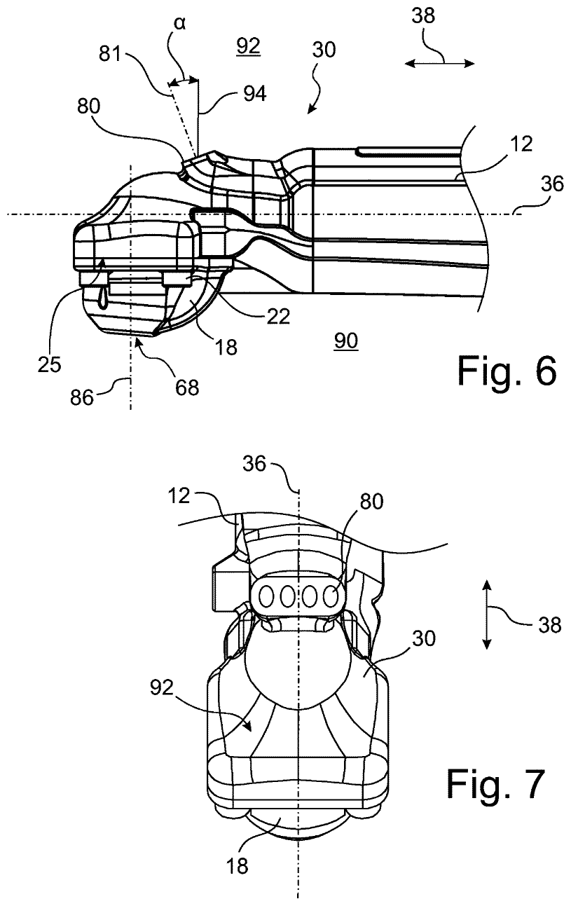

FIG. 6 schematically shows a detailed view of an output side of a burner housing part with a head part of the device for thermal spraying according to the second exemplary embodiment from FIG. 2;

FIG. 7 schematically shows a further detailed view of the output side of the burner housing part with the head part shown in FIG. 5;

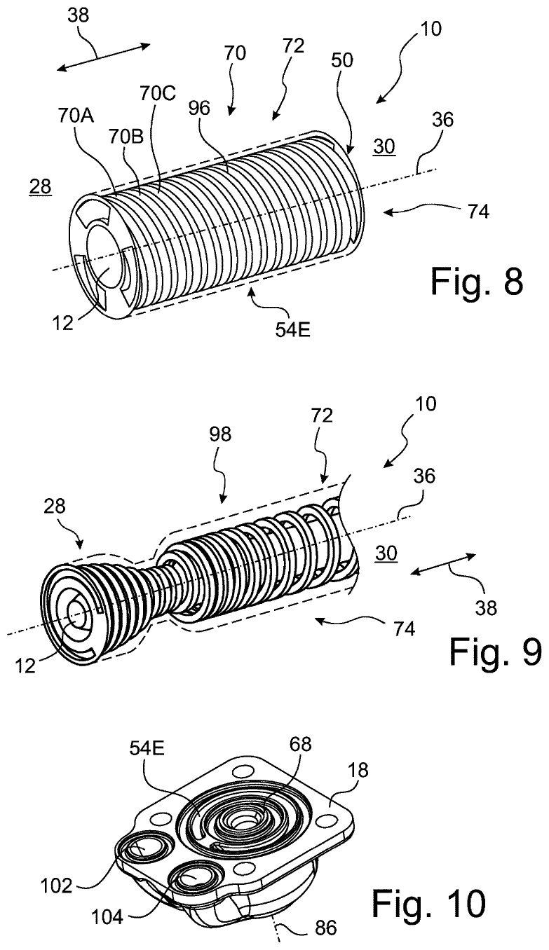

FIG. 8 schematically shows a perspective model view of a first exemplary internal cooling of the device for thermal spraying with helically shaped or formed cooling channels within the burner housing part;

FIG. 9 schematically shows a perspective model view of another exemplary internal cooling of the device for thermal spraying with a helically shaped or formed cooling channel with a modified pitch within the burner housing part;

FIG. 10 schematically shows a perspective model view of a possible cooling of a head part of the device for thermal spraying from FIG. 2 with an annularly formed or shaped cooling channel in the head part shown in FIGS. 5 and 6; and

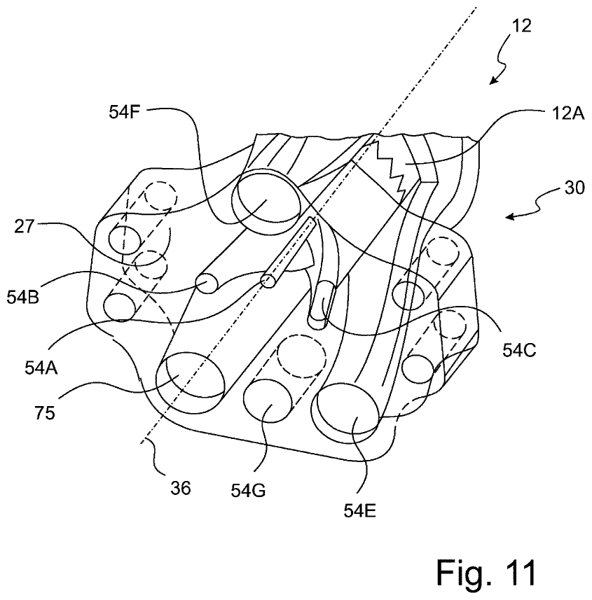

FIG. 11 schematically shows a perspective model view of a connecting flange part on an input side of the burner housing part of the device for thermal spraying.

The representations in FIGS. 1 and 2 show the proposed device for thermal spraying 1, in short device 1, for spraying a coating material 2 onto a substrate body 3 or 4 (often also referred to as substrate), schematically in at least two different embodiments, namely once in the embodiment of a thermal outer coating device 1A (see FIG. 1) for thermally spraying an outer coating 5 onto the outside 6 of the substrate body 3 and once in the form of a thermal internal coating device 1B (see FIG. 2) for thermally spraying an internal coating 7 onto the inside 8 of the substrate body 4.

The device 1 is structurally characterized by an extremely simple and particularly compact construction, since its core, namely a burner housing part 10 (burner), is produced by an additive manufacturing method.

In other words, in particular the burner housing part 10 of the device 1 is structurally simple and formed monolithically, i.e., in the sense of the invention, with a main body made of a single monolithic block 11.

The additively produced burner housing part 10 houses, among other things, the actual combustion chamber 12, in which different process media 14, such as kerosene or propane 14A, hydrogen 14B, oxygen 14C or optionally nitrogen 14D, can chemically react with each other, in short, are “burned,” in order to produce the actual thermal energy.

Due to the additively manufactured burner housing part 10 alone, the device 1 can be built with significantly fewer components than was previously customary in the prior art and can therefore also be manufactured much more compactly.

A more compact design with fewer components also requires, among other things, a smaller design, whereby the device 1 can be operated in a more thermally advantageous manner, in particular due to a lower consumption of process media 14, a limited loss of thermal energy to the environment 16 or the like, to name just a few advantageous effects.

The device 1 further comprises a head part 18 for dispensing the coating material 2 and a connection part 20 for the advantageous cumulative supply of process media 14.

The head part 18 and the connection part 20 can also be produced by means of an additive manufacturing method, but can also be produced conventionally.

The head part 18 and the connection part 20 can be flanged and fastened firmly but detachably to the burner housing part 10, for example by means of a screw connection 22 (numbered only as an example).

Due to the construction proposed here, the device 1 can also manage with significantly fewer component interfaces 24, 26 than previously customary in the prior art, namely with the first component interface 24 between the burner housing part 10 and the head part 18 and with a further component interface 26 between the burner housing part 10 and the connection part 20, wherein the further component interface 26 is arranged on the input side 28 of the burner housing part 10 and the first component interface 24 is arranged on the output side 30 of the burner housing part 10.

At the first component interface 24, the burner housing part 12 has a receiving surface 25 for receiving the head part 18, wherein the receiving surface 25 and the burner housing part 10 are monolithically formed or shaped.

Accordingly, the burner housing part 12 has a further receiving surface 27 at the second component interface 26 for receiving the connection part 20, wherein the further receiving surface 27 and the burner housing part 10 are also monolithically formed or shaped.

The receiving surfaces 25 and 27 are designed to be flat in such a way that the head part 18 on the one hand and the connection part 20 on the other hand are sealed accordingly with all transfer regions for fluid process media.

In this respect, both the head part 18 and the connection part 20 can be detachably but fixedly flanged to the burner housing part 10.

The input side 28 and the output side 30 are thus formed or shaped monolithically together, in particular as the single monolithic block 11.

Advantageously, transition regions 32, 34 between the combustion chamber 12 and the input side 28 and the output side 30 are also monolithically formed or shaped, namely input side transition regions 32 (numbered only as an example) on the input side 28 and output-side transition regions 34 (numbered only as an example) on the output side 30.

This also allows the device 1 to be constructed much more compactly, whereby it can be operated more efficiently, as already described above.

Alternatively, it is also possible for the head part 18 and/or the connection part 20 to be formed or shaped in one piece with the burner housing part 10, thus forming a monolithic unit with each other. This allows the number of possible component interfaces 24 or 26 to be further reduced.

However, the assembly solutions can often be considered more advantageous since, for example, the head part 18 is subject to greater wear and tear and can therefore be easily replaced. Thus, a burner housing part 10 can remain in operation for a considerably longer period if it can be equipped with a new head part 18.

With the replaceable connection part 20, the device 1 can be more easily configured for different operating modes, which can also differ by the supply of different process media 14. In this respect, the replaceable connection part 20 can provide different connection options in a compact and unproblematic manner on the device 1 or on its burner housing part 10.

The connection part 20 shown here has connections (not explicitly shown here) for the following process media 14: kerosene or propane 14A, hydrogen 14B, oxygen 14C, nitrogen 14D, internal coolant 14E, external cooling air 14E and particles 14G for the coating material 2.

The device 1 has a central longitudinal axis 36, along which the device 1, but also the burner housing part 10, extend with the corresponding longitudinal extent 38.

The illustrations in the further FIG. 3 to 11 describe in more detail the structure of individual components of the device 1, such as the burner housing part 10, the head part 18 and also the connection part 20, by way of example based on the design of the thermal internal coating device 1B (see FIG. 2), wherein the description is also largely applicable to the embodiment of the thermal external coating device 1A (see FIG. 1), but is not shown here again in detail with further illustrations in order to avoid repetition.

According to the different sectional views, in particular according to FIGS. 3 and 4, the device 1 is shown in more detail by way of example and described below.

The sectional views according to FIGS. 3 and 4 clearly show that the burner housing part 10 has a plurality of material recesses 40, in particular internal material recesses 40, which, due to the additive manufacturing method used, can be designed or formed in almost any desired manner, in particular extremely flow-optimized.

This also leads to a more efficient operation of the proposed device 1.

This is due, among other things, to the fact that almost all interfaces 42 (numbered only as an example) of the material recesses 40 can be designed or formed to be tangent-continuous with regard to their spatial extents, in particular at transitions 44 (numbered only as an example).

With regard to the transitions 44, only the transition 44 on the combustion chamber 12 between the pre-combustion chamber 12A and the main combustion chamber 12B is numbered as an example.

In particular, the interfaces 42 can be produced as free-form surfaces (not explicitly numbered again), which is generally not possible with conventional manufacturing methods, especially in the case of internal surfaces 46 (numbered only as an example) of a component formed as a monolithic block 11, such as in particular the present burner housing part 10.

Advantageously, interfaces 42 of the material recesses 40 and the burner housing part 10 are monolithically formed or shaped.

In addition, a wide variety of structures 48 can be arranged or formed on or within the material recesses 40 to produce additional effects, as will be described in more detail later, wherein the structures 48 and the burner housing part 10 are formed monolithically.

A hot gas channel 50 is connected to the combustion chamber 12, in particular to its main combustion chamber 12B, via which the process hot gas (not numbered) produced during the combustion of process media 14, such as in particular the kerosene or propane 14A or the hydrogen 14B, is discharged from the combustion chamber 12 into the environment 16.

The hot gas channel 50 has a curved section 52 on the output side 30 in order to be able to redirect the process hot gas within the burner housing part 10 by 90° so that it can exit the device 1 via the head part 18 into the environment 16.

The hot gas channel 50, in particular with its curved section 52, and the combustion chamber 12 or the burner housing 12 are monolithically formed or shaped.

On the input side 29 of the burner housing part 10, on the one hand, supply lines 54 to the combustion chamber 12 are arranged, such as a primary fuel supply line 54A for supplying kerosene or propane 14A, a secondary fuel supply line 54B for supplying hydrogen 14B, and an oxygen supply line 54° C. for supplying oxygen 14C, wherein these can be formed or shaped monolithically with the burner housing part 10.

On the other hand, a cooling channel 54E for supplying an internal coolant 14E for internal cooling and a cooling air channel 54F for supplying cooling air 14F for external cooling of the main body 4 to be coated are formed on the input side 28 in the sense of the supply lines 54.

In addition, the input side 28 forms a holder 58 for an injector tube part 54G for supplying particles 14G.

The primary fuel supply line 54A, the secondary fuel supply line 54B, the oxygen supply line 54C, the cooling channel 54E, the cooling air channel 54F and also the holder 58 are formed or shaped monolithically with the input side 28 and thus also with the burner housing part 10 or with the combustion chamber 12.

Alternatively, the injector tube part 54G can also be formed or shaped monolithically with the burner housing part 10.

The primary fuel supply line 54A opens into the combustion chamber 12 with a single injection nozzle 60, wherein the injection nozzle 60 and the combustion chamber 12 or the burner housing part 10 are monolithically formed or shaped.

The secondary fuel supply line 54B opens into the combustion chamber 12 with a plurality of other injection nozzles 62 (numbered only as an example), wherein the other injection nozzles 62 and the combustion chamber 12 or the burner housing part 10 are monolithically formed or shaped.

The other injection nozzles 62 are arranged concentrically and uniformly distributed around the injection nozzle 60 or around the longitudinal center axis 36.

The oxygen supply line 54C opens into the combustion chamber 12 with two annular gap nozzles 64 and 66, wherein the two annular gap nozzles 64, 66 and the combustion chamber 12 or the burner housing part 10 are monolithically formed or shaped.

Here, the two annular gap nozzles 64 and 66 are arranged concentrically around the injection nozzle 60 and around the longitudinal center axis 36, respectively, wherein the outer annular gap nozzle 66 is additionally arranged concentrically around the inner annular gap nozzle 64.

Overall, a nozzle arrangement 67 can be formed particularly advantageously on the burner housing part 10 with the injection nozzles 60, 62 and annular gap nozzles 64 and 66 or their circular or annular openings (not numbered again), wherein the nozzle arrangement 67 and the burner housing part 10 are formed or shaped monolithically.

In this embodiment, the cooling channel 54E is formed as a cooling ring channel (not numbered again).

The cooling channel 54E or the cooling ring channel extends from the input side 28 in a ring shape around and along the combustion chamber 12 to the output side 30 around and along the hot gas channel 50 and further in a ring shape into the head part 18, where it also encloses the discharge nozzle 68 of the device 1.

Here, the cooling channel 54E or the cooling ring channel and the combustion chamber 12 or the burner housing part 10 are monolithically formed or shaped.

Due to this monolithic design or construction, the cooling performance can be increased and the device 1 can be cooled very uniformly overall, which also makes the operation of the device 1 much more efficient overall.

In order to further improve the cooling performance, the cooling channel 54E or the cooling ring channel has, as structures 48, some guide elements 70 (numbered only as an example).

These guide elements 70 can be realized with different guide geometries, for example as guide vane elements, as guide fin elements, as guide helix elements 70A, 70b, 70C (cf. FIG. 8) or 98 (cf. FIG. 9), or the like.

By means of such guide elements 70, a coolant flowing in the cooling channel 54E can be guided more effectively through this cooling channel 54E, for example in the form of a coolant helix 72 (see FIGS. 8 and 9), whereby the internal coolant 14E is better mixed, thereby avoiding in particular “dead water areas” and the cooling performance on the device 1 or specifically along the burner housing part 10 can be evened out and further improved overall.

By means of the cooling channel 54E and in particular also by means of the guide elements 70 formed therein, a particularly effective internal cooling 74 can be realized on the device 1 and in particular on the burner housing part 10, wherein the internal cooling 74 and the burner housing part 10 are formed monolithically.

Preferably, the internal cooling 74 is designed as a circulation system not further shown and numbered here or is formed in particular in the burner housing part 10, wherein to realize the circulation system, a corresponding return channel 75 (shown only as an example) for returning the heated internal coolant 14E is formed specifically in the burner housing part 10.

The return channel 75 and the burner housing part 10 are formed or formed monolithically together.

The cooling air channel 54F extends in the burner housing part 10 from its input side 28 into its output side 30 and the cooling air channel 54F ends at the output side 30 in four cooling nozzles 80 (see in particular also FIGS. 6 and 7) for ejecting coolant in the form of cooling air, wherein the cooling nozzles 80 and the burner housing part 10 are formed monolithically.

The cooling nozzles 80 each have a main ejection axis 81 along which the coolant is sprayed out of the cooling nozzles 80.

The cooling air channel 54F and the cooling nozzles 80 together represent a cooling device 82 for cooling the substrate body 4 on the device 1 and in particular on the burner housing part 10, wherein the cooling device 82 or at least regions thereof and the burner housing part 10 are formed monolithically.

The injector tube part 54G also extends from the input side 28 to the output side 30 and ends in an injector element 84 of the head part 18, by means of which the particles 14G can be introduced into the discharge nozzle 68 substantially orthogonally to a main coating axis 86.

At this point it should also be mentioned that the connection part 20 is designed and in particular shaped in such a way that the process media 14 required for operating the device 1 can be transferred at the further component interface 26 into the corresponding supply lines 54 of the burner housing part 10 in an operationally safe manner.

According to the illustration in FIG. 5, the input side 28 of the burner housing part 10 is shown again in an enlarged manner, although not all reference signs need to be shown here either.

Better visible are, in particular, the primary fuel supply line 54A with its injection nozzle 60, the secondary fuel supply line 54B with its injection nozzles 62, the oxygen supply line 54C with its two annular gap nozzles 64 and 66 and the annular cooling channel 54E.

With regard to the secondary fuel supply line 54B, a flame arrester device 63 can also be seen in this illustration, which is arranged as a thin-meshed material mesh 63A, monolithically formed immediately from the burner housing part 12, within the secondary fuel supply line 54B.

By means of the thin-meshed material mesh 63A within the secondary fuel supply line 54B, the risk of the hydrogen 14B igniting critically already in the secondary fuel supply line 54B can be excluded or reduced, wherein the flame arrester device 63, in particular the thin-mesh material mesh 63A, and the burner housing part 10 are formed monolithically.

The thin-meshed material mesh 63A has a base area (not separately numbered) which, in terms of its diameter, depends on the cross-sectional area (not numbered) of the secondary fuel supply line 54B. Here, the base area with a dimension of 175 mm² is also circular in shape.

Furthermore, the thin-meshed material mesh 63A has a length of 30 mm, seen in the longitudinal extent 38 of the burner housing part 10 and thus also in the longitudinal extent 38 of the secondary fuel supply line 54B.

Furthermore, according to the illustration in FIG. 5, a wall 10A of the combustion chamber 12 in the burner housing part 10 is shown in more detail by way of example, more precisely an inner wall 10A between the interface 42 of the combustion chamber 12 and the cooling channel 54E.

In particular, this inner wall 10A has a plurality of cavities 10B (shown only schematically).

The cavities 10B have a diameter (not explicitly shown) which in this embodiment is 50% of the wall thickness 10C of the wall 10A.

This makes it possible to use the process energy produced in the combustion chamber 12 more effectively.

If the cavities 10B are distributed uniformly over the surface or interface 42 of the wall 10A of the combustion chamber 10, a particularly uniform heat distribution at the burner housing part 12 can be achieved.

The cavities 10B can be formed or shaped differently in the material of the burner housing part 12. Preferably, the cavities 10B are designed or formed as circular or spherical pores (not separately numbered again).

On the one hand, the cavities 10B can thereby be produced with the largest and most homogeneous surface possible in the burner housing part 10.

On the other hand, forces and stresses occurring in the wall 10A can continue to be absorbed or transmitted within the burner housing part 10 in a well-tolerated manner.

Overall, the present cavities 10B make it possible to construct the burner housing part 10 in a more energy-efficient and compact manner, whereby the device 1 can also be operated more efficiently.

According to the illustrations in FIGS. 6 and 7, the output side 30 of the burner housing part 10 with the head part 18 attached thereto is shown again.

The head part 18 is flanged to the burner housing part 10 at the bottom of the receiving surface 25, wherein the main coating axis 86 of the discharge nozzle 68 runs orthogonally to the central longitudinal axis 36 of the device 1 or of the burner housing part 10.

The discharge nozzle 68 marks the front side 90 of the device 1 or the burner housing part 10, while the four cooling nozzles 80 are arranged on the rear side 92 of the device 1 or the burner housing part 10, in such a way that their corresponding main ejection axes 81 are at an angle of attack α=45° to an orthogonal 94 of the central longitudinal axis 36.

The four cooling nozzles 80 are arranged parallel to each other.

According to the illustration in FIG. 8, with regard to the guide elements 70, an alternative guide geometry for an internal cooling 74 is shown schematically in conjunction with the combustion chamber 12 of the burner housing part 10, namely in the form of a monolithic arrangement of triple guide helix elements 70A, 70B and 70C, by means of which three separate cooling channels 54E (numbered only as an example) are formed along the central longitudinal axis 36 of the burner housing part 10.

The three guide helix elements 70A, 70B and 70C each extend helically from the input side 28 of the burner housing part 10 to the output side 30 of the burner housing part 10 and preferably into the head part 18.

The three guide helix elements 70A, 70B and 70C each have, as seen in the longitudinal extent 38, 16 successively arranged flights 96 (numbered only as an example) or turns, which enclose the combustion chamber 12 and the adjoining hot gas channel 50 in a cylindrical shape and are guided further around the discharge nozzle 68 placed in the head part 18.

By means of the three guide helix elements 70A, 70B and 70C, a particularly uniform and good cooling can be achieved, especially towards the combustion chamber 12 as well as the hot gas channel 50 in the burner housing part 10 and the discharge nozzle 68 in the head part 18.

The three guide helix elements 70A, 70B and 70C are again designed or formed as suitably shaped guide elements 70 with the burner housing part 10 monolithically in such a way that the burner housing part 10 has three spatially separated cooling channels 54E.

A similar effect can alternatively be achieved by means of suitably designed or shaped guide vane elements (not shown), which are arranged individually to one another and extend in the burner housing part 10 in a helical manner around the combustion chamber 12 and the hot gas channel 50, each with a length of, for example, 3 mm to 50 mm.

These guide vane elements, which are arranged separately from one another, can form ring regions in a corresponding cooling channel 54E along which the coolant 54E can be guided through the cooling channel 54E.

For example, two such guide vane elements can be provided per ring region (turn or flight 96).

Depending on the design of the guide geometry, up to 20 such ring regions can be monolithically formed by means of the burner housing part 10.

The axial distance between the individual ring regions or their guide vane elements is preferably from 0.5 mm, for example as seen in the longitudinal extent 38 of the burner housing part 10. An axial overlap of ring regions can be advantageous due to the design.

In any case, the radial offset should be chosen uniformly depending on the number of ring regions in order to achieve the most uniform flow conditions in the cooling channel 54E and thus also uniform cooling overall.

These guide vane elements, which are arranged individually relative to one another, preferably also have a curved profile, so that the coolant 14E experiences an additional swirl when flowing over the correspondingly profiled surfaces of the guide vane elements.

Alternatively, surface profiles other than the curved profile can also be formed on a guide element 70 in order to be able to additionally set the coolant 14E into rotation along its flow direction in the cooling channel 54E.

Preferably, three guide helix elements 70A, 70B and 70C extend from the input side 28 of the burner housing part 10 to the output side 30 of the burner housing part 10.

According to the illustration in FIG. 9, in order to realize a different internal cooling 74 with respect to guide elements 70, a further alternative guide geometry is schematically illustrated in connection with the combustion chamber 12 of the burner housing part 10, namely in the form of a single guide helix element 98, which has a changing pitch (not numbered) along the central longitudinal axis 36 of the burner housing part 10.

Preferably, the single guide helix element 98 extends from the input side 28 of the burner housing part 10 to its output side 30.

At this point, it should also be mentioned that, cumulatively or alternatively, guide elements 70 can be configured by means of a curved profile (not shown) to give the coolant an additional swirling movement, whereby the coolant can be mixed even more intensively.

The coolant can be realized as normal cooling water, as a cooling emulsion, as a cooling mixture thereof, or the like.

According to the illustration in FIG. 10, the head part 18 of the device 1 is again shown in a partially sectional view, wherein it can be clearly seen how the discharge nozzle 68 is seated in the head part 18, surrounded by the cooling channel 54E.

The cooling channel 54E opens within the head part 18 into two return ports 102 and 104, by means of which the heated coolant 14E can be transferred into the return channel 75 of the burner housing part 10.

According to the illustration in FIG. 11, the burner housing part 10 is shown again with regard to its input side 28 and the supply lines 54 formed therein in a tangentially continuous manner, specifically the primary fuel supply line 54A for supplying kerosene or propane 14A, the secondary fuel supply line 54B for supplying hydrogen 14B, the oxygen supply line 54C for supplying oxygen 14C, the cooling channel 54E for supplying an internal coolant 14E for internal cooling, the cooling air channel 54F for supplying cooling air 14F for external cooling of the main body 4 to be coated and the return channel 75 for returning or discharging the heated internal coolant 14E.

Through a tangentially continuous design, the supply lines 54 can be designed or shaped in a fluidically advantageous manner, whereby a loss-free flow of the process media can be achieved.

### LIST OF REFERENCE SIGNS

1 device for thermal spraying
1A embodiment of an external coating device
1B embodiment of an internal coating device
2 coating material
3 main body
4 further main body
5 outer coating
6 outer side
7 internal coating
8 inner side
10 burner housing part
10A wall or inner wall
10B cavities
10C wall thickness
11 monolithic block
12 combustion chamber
12A pre-combustion chamber
12B main combustion chamber
14 process media
14A kerosene or propane
14B hydrogen
14C oxygen
14D nitrogen
14E internal coolant
14F cooling air
14G particles (coating material)
16 environment
18 head part
20 connection part
22 screw connections
24 first component interface
25 receiving surface
26 further component interface
27 further receiving surface
28 input side
30 output side
32 input-side transition regions
34 output-side transition regions
36 central longitudinal axis
38 longitudinal extent
40 material recesses
42 interfaces
44 transitions
46 surfaces
48 structures
50 hot gas channel
52 curved section
54 supply lines
54A primary fuel supply line
54B secondary fuel supply line
54C oxygen supply line
54E cooling channel or cooling ring channel
54F cooling air channel
54G injector tube part
58 holder
60 injection nozzle or primary fuel nozzle
62 other injection nozzles or secondary fuel nozzle
63 flame arrester device
63A material mesh
64 inner annular gap nozzle
66 outer annular gap nozzle
67 nozzle arrangement
68 discharge nozzle
70 guide elements
70A first guide helix element
70B second guide helix element
70C third guide helix element
72 coolant helix or cooling channel helix
74 internal cooling
75 return channel
80 cooling nozzles
81 main ejection axes
82 cooling device
84 injector element
86 main coating axis
90 front side
92 rear side
94 an orthogonal
96 flights
98 single guide helix element
102 first return port
104 second return port
α angle of attack

1. A device for thermally spraying a coating material onto a substrate body to be coated, comprising:
a burner housing part having a combustion chamber,
an input side for supplying process media, and
an output side for dispensing a process hot gas,
wherein the burner housing part is produced by means of an additive manufacturing method.

2. The device according to claim 1, characterized in that the burner housing part is monolithic.

3. The device according to claim 1, characterized in that the input side and the output side are formed monolithically with each other.

4. The device according to claim 1, characterized in that transition regions between the combustion chamber and the input side and the output side are formed monolithically.

5. The device according to claim 1, characterized in that the burner housing part has material recesses, wherein interfaces of the material recesses and the burner housing part are formed monolithically.

6. The device according to claim 1, characterized in that structures are arranged on or within material recesses of the burner housing part, wherein the structures and the burner housing part are formed monolithically.

7. The device according to claim 1, characterized in that the input side has a first supply line for a primary fuel, wherein the first supply line and the combustion chamber are formed monolithically.

8. The device according to claim 1, characterized in that the input side has further supply lines for further process media wherein the further supply lines and the combustion chamber are formed monolithically.

9. The device according to claim 1, characterized in that the output side has a hot gas channel, wherein the hot gas channel and the combustion chamber are formed monolithically.

10. The device according to claim 9, characterized in that the hot channel has at least one curved section.

11. The device according to 10 claim 1, characterized in that supply lines for supplying process media on the input side of the burner housing part and a hot gas channel for discharging a process hot gas on the output side of the burner housing part are formed monolithically.

12. The device according to 11 claim 1, characterized in that the device has a head part with a discharge nozzle element and with an injector element for injecting coating material into the head part, wherein the head part is produced by means of an additive manufacturing method.

13. The device according to claim 12, characterized in that the head part and the burner housing part are formed monolithically,

14. The device according to claim 12, characterized in that the head part and the burner housing part are fixedly but detachably operatively connected to one another.

15. The device according to claim 14, characterized by a receiving surface for receiving the head part, wherein the receiving surface and the burner housing part are formed monolithically.

16. The device according to claim 1, characterized in that the device has an injector tube part for providing coating material to an injector element of a head part of the device wherein the burner housing part forms a holder for holding the injector tube part.

17. The device according to claim 1, characterized by a cooling device for cooling the substrate body, wherein the cooling device or at least regions thereof and the burner housing part are formed monolithically.

18. The device according to claim 17, characterized in that the cooling device has at least one coolant channel for guiding coolant , which extends from the input side of the burner housing part to the output side of the burner housing part, wherein the at least one coolant channel and the burner housing part are formed monolithically.

19. The device according to claim 17, characterized in that the cooling device has at least one cooling nozzle for ejecting coolant, which nozzle is arranged in particular on the output side of the burner housing part, wherein the at least one cooling nozzle and the burner housing part are formed monolithically.

20. The device according to claim 1, characterized by a flame arrester device, wherein the flame arrester device and the burner housing part are formed monolithically.

21. The device according to claim 20, characterized in that the flame arrester device has a material mesh, wherein the material mesh the burner housing part are formed monolithically.

22. The device according to claim 20 characterized in that the material mesh has a mesh size less than or equal to 1 mm.

23. The device according to claim 20, characterized in that the material mesh has a base area of 20 mm 2 or more, and of 700 mm² or less, wherein the base area is circular.

24. The device according to claim 20, characterized in that the material mesh has a length of 15 mm or more, and 90 mm or less.

25. The device according to claim 1, characterized by an internal cooling means for cooling the device wherein the internal cooling means and the burner housing part are formed monolithically.

26. The device according to claim 25, characterized in that the internal cooling has at least one cooling channel, wherein the at least one cooling channel or the cooling channels and the burner housing part are formed monolithically.

27. The device according to claim 26, characterized in that the at least one cooling channel is designed close to the contour.

28. The device according to claim 26 27, characterized in that the at least one cooling channel is formed in a ring shape on the head part.

29. The device according to claim 26, characterized in that the at least one cooling channel extends from the input side to the output side through the burner housing part.

30. The device according to claim 26, characterized in that the at least one cooling channel extends helically within the burner housing part, wherein a cooling channel helix has at least one flight and up to 16 flights.

31. The device according to claim 26, characterized in that the internal cooling has guide elements for guiding a coolant, wherein the guide elements and the burner housing part are formed monolithically.

32. The device according to claim 31, characterized in that guide elements extend helically within the burner housing part, wherein a guide element helix has at least one single flight and up to 16 flights.

33. The device according to claim 31, characterized in that guide elements are arranged individually one behind the other within the burner housing part, wherein the individually arranged guide elements each have a length of 3 mm or more and of 50 mm or less.

34. The device according to claim 31, characterized in that guide elements are designed by means of a curved profile to give the coolant an additional swirling movement.

35. The device according to claim 31, characterized in that guide elements have a wall thickness of 0.1 mm or more and 5 mm or less.

36. The device according to claim 1, characterized in that supply lines for process media, in the burner housing part are designed to be tangentially continuous.

37. The device according to claim 1, characterized in that openings, of a nozzle arrangement on the combustion chamber are formed monolithically with the burner housing part.

38. The device according to claim 1, characterized in that primary and secondary fuel nozzles on the combustion chamber are formed monolithically with the burner housing part.

39. The device according to claim 1, characterized in that one interface of the combustion chamber has a plurality of valleys and/or grooves, wherein the valleys and/or grooves and the burner housing part are formed monolithically.

40. The device according to claim 1, characterized in that one interface of the combustion chamber has a roughness Rₐ of 5 μm or more, or a roughness Rₐ of 100 μm or less.

41. The device according to claim 1, characterized in that one wall of the combustion chamber has a plurality of cavities pores, wherein the cavities have a diameter which is selected in particular as a function of a wall thickness of a wall of the combustion chamber.

42. The device according to claim 41, characterized in that the diameter of a cavity is 10% of the wall thickness or more, or 75% of the wall thickness or less,

43. The device according to claim 41, characterized in that the cavities are arranged uniformly over the surface of the wall of the combustion chamber.

44. The device according to claim 1, characterized in that the cavities are arranged separately from a coolant located in a cooling channel.

45. A manufacturing method for manufacturing a device for thermally spraying a coating material onto a substrate body to be coated, the device comprising a burner housing part having a combustion chamber, an input side for supplying process media, and an output side for dispensing a process hot gas, in which at least the burner housing part of the device is produced by means of an additive manufacturing method.

46. A use of an additive manufacturing method for producing a burner housing part of a device for thermally spraying a coating material onto a substrate body to be coated.
